(19) United States
(12) Patent Application Publication
(10) Pub. No.: US 2026/0169628 A1
(43) Pub. Date: Jun. 18, 2026

(54) STORAGE DEVICE MOUNTED ON VEHICLE, AND METHOD OF OPERATING THE SAME

(71) Applicant: SAMSUNG ELECTRONICS CO., LTD., Suwon-si (KR)

(72) Inventors: SANG-HWA JIN, Suwon-si (KR); Jongin Lee, Suwon-si (KR)

(73) Assignee: SAMSUNG ELECTRONICS CO., LTD., Suwon-si (KR)

(21) Appl. No.: 19/303,770

(22) Filed: Aug. 19, 2025

(30) Foreign Application Priority Data
Dec. 17, 2024 (KR) 10-2024-0188798

(51) Int. Cl. G06F 3/06

(52) U.S. Cl. CPC G06F 3/0611; G06F 3/0659; G06F 3/0673

(57) ABSTRACT

A storage device is provided. The storage device includes: a non-volatile memory device including a software memory region configured to store first instructions; and a storage controller configured to implement a message manager by executing the first instructions. The message manager is configured to: receive environment data of a vehicle from a sensor device mounted on the vehicle; and generate message data configured to contribute to driving of the vehicle based on the environment data.

### CROSS-REFERENCE TO RELATED APPLICATION

This application claims priority under 35 U.S.C. § 119 to Korean Patent Application No. 10-2024-0188798, filed on Dec. 17, 2024, in the Korean Intellectual Property Office, the disclosure of which is incorporated by reference herein in its entirety.

### BACKGROUND

The present disclosure relates to a storage device, and more particularly, relate to a storage device mounted on a vehicle and a method of operating the same.

A memory device may store data in response to a write request and may output data stored therein in response to a read request. The memory device may be classified as a volatile memory device, which loses data stored therein when a power is turned off, such as a dynamic random access memory (DRAM) device or a static RAM (SRAM) device, or a non-volatile memory device, which retains data stored therein even when a power is turned off, such as a flash memory device, a phase-change RAM (PRAM), a magnetic RAM (MRAM), or a resistive RAM (RRAM).

A non-volatile memory device may be used as a storage device storing a large amount of data. A vehicle may provide a driving function under control of a driver and may also provide various functions of convenience. A storage device mounted on the vehicle may store data corresponding to various functions.

### SUMMARY

One or more embodiments provide a storage device mounted on a vehicle and a method of operating the same.

According to an aspect of an embodiment, a storage device includes: a non-volatile memory device including a software memory region configured to store first instructions; and a storage controller configured to implement a message manager by executing the first instructions. The message manager is configured to: receive environment data of a vehicle from a sensor device mounted on the vehicle; and generate message data configured to contribute to driving of the vehicle based on the environment data.

According to another aspect of an embodiment, a storage device includes: a non-volatile memory device including a first memory region, a second memory region, and a software memory region configured to store instructions; and a storage controller configured to implement a message manager by executing the instructions. A first read speed corresponding to the first memory region is faster than a second read speed corresponding to the second memory region. The message manager is configured to: identify message data configured to contribute to driving of a vehicle; determine whether a maximally allowed response time corresponding to period information of a field of the message data is shorter than a threshold time; store the field of the message data in the first memory region in response to determining that the maximally allowed response time is shorter than the threshold time; and store the field of the message data in the second memory region in response to determining that the maximally allowed response time is not shorter than the threshold time.

According to another aspect of an embodiment, a method of operating a storage device which is mounted on a vehicle, includes: receiving environment data of the vehicle from a sensor device mounted on the vehicle; generating message data configured to contribute to driving of the vehicle based on the environment data, wherein the message data includes a header and a field; determining whether a maximally allowed response time corresponding to period information of the field of the message data is shorter than a threshold time; and storing the field of the message data in a first memory region among the first memory region and a second memory region of the storage device in response to determining that the maximally allowed response time is shorter than the threshold time. A first read speed corresponding to the first memory region is faster than a second read speed corresponding to the second memory region.

### BRIEF DESCRIPTION OF DRAWINGS

The above and other objects and features will be more apparent from the following description of embodiments, taken in conjunction with the accompanying drawings.

FIG. 1 is a block diagram of a vehicle according to an embodiment.

FIG. 2 is a block diagram describing a related vehicle.

FIG. 3 is a block diagram of a vehicle according to some embodiments.

FIG. 4 is a table describing message data according to some embodiments.

FIG. 5 is a table describing a message type of message data according to some embodiments.

FIG. 6 is a table describing an example of message data according to some embodiments.

FIG. 7 is a table describing a service according to some embodiments.

FIG. 8 is a block diagram of a storage controller according to some embodiments.

FIG. 9 is a diagram describing a method of operating a vehicle according to some embodiments.

FIG. 10 is a diagram describing a method of operating a vehicle according to some embodiments.

FIG. 11 is a flowchart describing a method of operating a storage device according to some embodiments.

FIG. 12 is a diagram describing an example of a vehicle according to some embodiments.

### DETAILED DESCRIPTION

Below, embodiments will be described in detail and clearly to such an extent that one skilled in the art carries out embodiments of the present disclosure easily. Like components are denoted by like reference numerals throughout the specification, and repeated descriptions thereof are omitted. Embodiments described herein are example embodiments, and thus, the present disclosure is not limited thereto, and may be realized in various other forms. Each embodiment provided in the following description is not excluded from being associated with one or more features of another example or another embodiment also provided herein or not provided herein but consistent with the present disclosure.

As used herein, each of the phrases such as “A or B”, “at least one of A or B”, “at least one of A and B”, “at least one of A, B, or C”, “at least one of A, B, and C”, and “at least one of B or C” may include any one of items listed together in the corresponding phrase, or all possible combinations thereof. For example, the expression, “at least one of a, b, and c,” should be understood as including only a, only b, only c, both a and b, both a and c, both b and c, or all of a, b, and c.

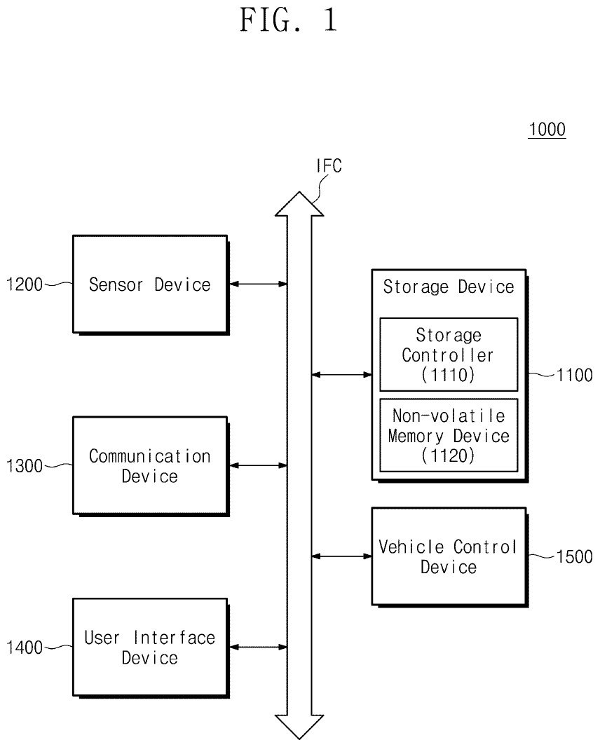

FIG. 1 is a block diagram of a vehicle according to an embodiment. Referring to FIG. 1, a vehicle 1000 may include a storage device 1100, a sensor device 1200, a communication device 1300, a user interface device 1400, a vehicle control device 1500, and an interface bus circuit IFC. The storage device 1100, the sensor device 1200, the communication device 1300, the user interface device 1400, and the vehicle control device 1500 may communicate with each other through the interface bus circuit IFC.

The vehicle 1000 may correspond to various types of motor vehicles. In some embodiments, the vehicle 1000 may be an automobile. The vehicle 1000 may provide a driving function according to the control of the driver. In addition to the driving function according to the direct control of the driver, the vehicle 1000 may provide various functions, such as an autonomous driving service, a safe driving service, and a route guidance service, to the driver or passenger of the vehicle 1000. In addition, the vehicle 1000 may provide various functions or additional functions (e.g., a traffic, prevention of collision, and warning) derived from the various functions to a vehicle different from the vehicle 1000, roadside equipment (RSE), or a user terminal of a pedestrian, etc.

The storage device 1100 may include a storage controller 1110 and a non-volatile memory device 1120. The storage device 1100 may store data related to various functions of the vehicle 1000 and may provide the stored data to other components of the vehicle 1000.

The storage controller 1110 may receive data from other components of the vehicle 1000 or may internally generate data. The storage controller 1110 may store data in the non-volatile memory device 1120. The storage controller 1110 may read the data stored in the non-volatile memory device 1120. The storage controller 1110 may provide the read data to other components of the vehicle 1000 or may generate other data based on the read data.

The non-volatile memory device 1120 may store data under control of the storage controller 1110. The non-volatile memory device 1120 may retain data present therein even when a power is turned off. For example, the non-volatile memory device 1120 may be implemented with a NAND flash memory device, a NOR flash memory device, a phase-change RAM (PRAM), a magnetic RAM (MRAM), a resistive RAM (RRAM), etc.

The sensor device 1200 may be mounted on the vehicle 1000. The sensor device 1200 may sense an ambient environment of the vehicle 1000 and may generate environment data indicating the sensed ambient environment. The sensor device 1200 may provide the environment data to the storage device 1100. For example, the sensor device 1200 may include various kinds of sensors such as an image sensor, a radar sensor, a light detection and ranging (LIDAR) sensor, a ultrasonic sensor, a global positioning system (GPS) sensor, a moving direction detecting sensor, a speed sensor, a brake system status detecting sensor, a temperature sensor, and a humidity sensor.

The communication device 1300 may be mounted on the vehicle 1000. The communication device 1300 may support a wireless communication with another (e.g., external) communication device within a communication range. The communication device 1300 may provide data received from the external communication device to the storage device 1100 or may provide data received from the storage device 1100 to the external communication device.

For example, the communication device 1300 may support wireless communication of a vehicle-to-vehicle (V2V) communication type for communication with another (i.e., external) vehicle within the communication range. The communication device 1300 may support wireless communication of a vehicle-to-infrastructure (V2I) communication type for communication with the RSE within the communication range. The communication device 1300 may support wireless communication of a vehicle-to-pedestrian (V2P) communication type for communication with a user terminal of a pedestrian within the communication range. The communication device 1300 may support wireless communication of a vehicle-to-everything (V2X) communication type for communication with an external communication device within the communication range.

The user interface device 1400 may provide an interface to the driver or passenger of the vehicle 1000. The user interface device 1400 may receive a control signal from the driver or passenger of the vehicle 1000 and may provide the control signal to the corresponding component of the vehicle 1000. For example, the user interface device 1400 may include a touch screen, a display device, a control button, a remote control device, a remote control application, a microphone, a speaker, etc.

The vehicle control device 1500 may control the driving of the vehicle 1000 under control of the driver of the vehicle 1000. In some embodiments, the vehicle control device 1500 may further control the driving of the vehicle 1000 under control of the storage controller 1110, the communication device 1300, or the user interface device 1400. In some embodiments, the vehicle 1000 may further include a host device which executes an application providing the autonomous driving service, and the vehicle control device 1500 may provide the autonomous driving service under control of the host device.

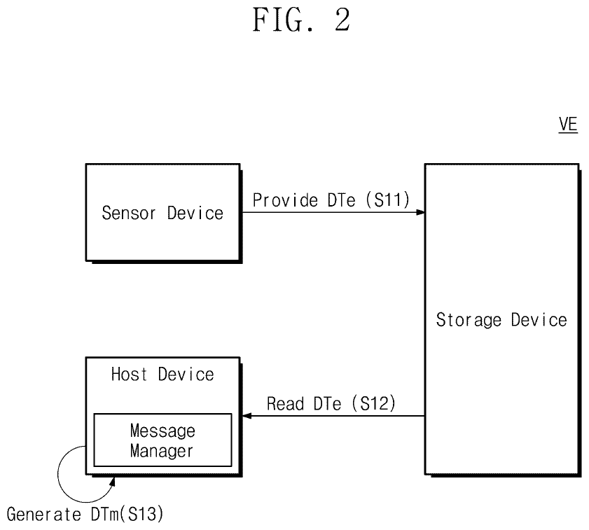

FIG. 2 is a block diagram describing a related vehicle. Referring to FIG. 2, a related vehicle VE may include a storage device, a sensor device, and a host device.

The storage device may communicate with the sensor device and the host device. The sensor device may sense an ambient environment of the related vehicle VE and may generate environment data DTe indicating the sensed ambient environment. The host device may implement a message manager. For example, the message manager may be implemented by a software module. The host device may include a host processor and a host memory. The host processor may implement the message manager by executing instructions stored in the host memory.

In operation S11, the sensor device may provide the environment data DTe to the storage device. The environment data DTe may indicate the ambient environment of the related vehicle VE sensed by the sensor device. The storage device may store the environment data DTe.

In operation S12, the message manager of the host device may read the environment data DTe stored in the storage device.

In operation S13, the message manager of the host device may generate message data DTm based on the environment data DTe. The message data DTm may include information contributing to the driving of the related vehicle VE.

As described above, according to the related vehicle VE, the message data DTm may be generated only by the host device. When the related vehicle VE does not include the host device or when the host device of the related vehicle VE does not support the message data DTm, the related vehicle VE may fail to provide various functions which are based on the message data DTm.

In addition, as the transmission of the environment data DTe from the storage device to the host device is required for the host device to generate the message data DTm, the input/output (I/O) load between the host device and the storage device may be increased.

Also, the message data DTm may contribute to the safety of driving in addition to the convenience of the related vehicle VE, but the storage device may manage the message data DTm without consideration of the importance of the message data DTm. In this case, the storage device may fail to satisfy the required performance (e.g., a low latency or a fast processing speed for the message data DTm). The delay of the message data DTm may cause a risk while driving the related vehicle VE.

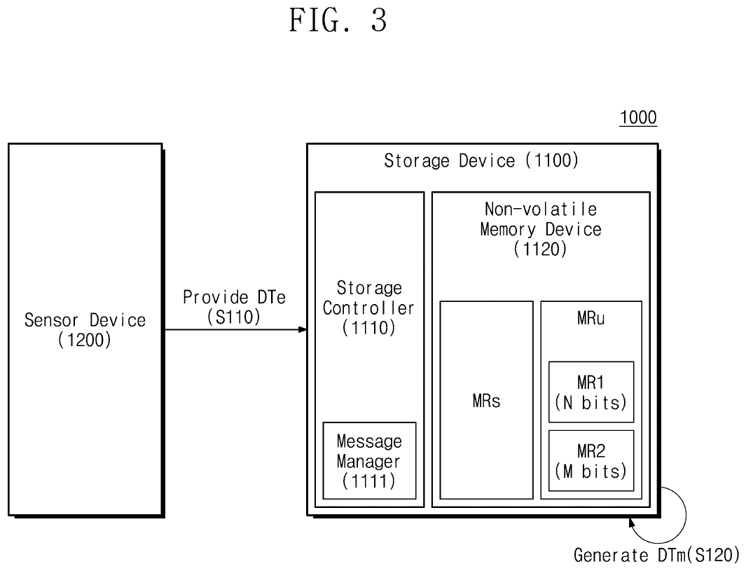

FIG. 3 is a block diagram of a vehicle according to some embodiments. Referring to FIG. 3, the vehicle 1000 may include the storage device 1100 and the sensor device 1200. The storage device 1100 may communicate with the sensor device 1200.

The sensor device 1200 may sense an ambient environment of the vehicle 1000 and may generate the environment data DTe indicating the sensed ambient environment.

The storage device 1100 may support a computational storage function. The computational storage function may refer to a function in which some functions off-loaded from the host device are performed by the storage device. For example, the storage device 1100 may support the TP4091 standard and/or the TP4131 standard distributed by a non-volatile memory express (NVMe) computational storage task group. The storage device 1100 manage a Non Volatile Memory (NVM) namespace, a Subsystem Local Memory (SLM) namespace, and a compute namespace.

The NVM namespace may be used for a storage function of the storage device 1100 (e.g., a general data storage function except for the compute function). The SLM namespace may be used to manage data (i.e., input data and output data) which are used for the off-loaded compute module. The compute namespace may be used to manage or execute a software module which performs the off-loaded compute function. The compute namespace may be managed by another device (e.g., a Field Programmable Gate Array (FPGA) or an Advanced Reduced Instruction Set Computer (RISC) Machine (ARM) processor) connected to the storage device 1100.

The storage device 1100 may include the storage controller 1110 and the non-volatile memory device 1120. The storage controller 1110 may include a message manager 1111. For example, the message manager 1111 may be implemented by hardware operating according to software instructions. The storage controller 1110 may include a processor and a volatile memory device.

The processor may implement the message manager 1111 by storing (e.g., downloading) instructions corresponding to the software module from the outside (e.g., a supplier of the vehicle 1000 or a server device or host device of a partner providing the autonomous driving function of the vehicle 1000) of the storage device 1100 to the non-volatile memory device 1120, loading the instructions stored in the non-volatile memory device 1120 to the volatile memory device, and executing the instructions loaded to the volatile memory device.

For example, when the message manager 1111 is implemented based on the computational storage function, the message manager 1111 may be implemented using a software module on the compute namespace. The input data and the output data of the message manager 1111 may be stored in the SLM namespace.

The non-volatile memory device 1120 may include a software memory region MRs and a user memory region MRu. The software memory region MRs may store instructions corresponding to the message manager 1111.

In some embodiments, the non-volatile memory device 1120 may further include a firmware memory region. The firmware memory region may be provided independently of the software memory region MRs. For example, the firmware memory region may store instructions corresponding to a firmware module for an initialization operation, a data management operation, etc. of the storage device 1100. The firmware module may be provided from the supplier of the storage device 1100. The software memory region MRs may store instructions corresponding to the software module which manages the message data DTm contributing to the driving of the vehicle 1000.

The message data DTm may include a header and a field. The header may indicate a message type and may be also referred to as “header data” or a “header item”. The field may describe contents corresponding to the message type and may be also referred to as “field data” or a “field item”.

The user memory region MRu may store the field of the message data DTm. The user memory region MRu may include a first memory region MR1 and a second memory region MR2. A first read speed corresponding to the first memory region MR1 may be faster than a second read speed corresponding to the second memory region MR2.

For example, the first memory region MR1 may include a plurality of first memory cell transistors, each of which stores N-bit information. “N” is a natural number. The second memory region MR2 may include a plurality of second memory cell transistors, each of which stores M-bit information. “M” is a natural number greater than “N”.

In detail, when the first memory region MR1 is implemented with a single level cell (SLC) type memory cell transistors storing one bit, the second memory region MR2 may be implemented with a multi-level cell (MLC) type of memory cell transistors storing two bits, a triple level cell (TLC) type of memory cell transistors storing three bits, or a quadruple level cell (QLC) type of memory cell transistors storing four bits. Alternatively, when the first memory region MR1 is implemented in the TLC type, the second memory region MR2 may be implemented in the QLC type.

However, the present disclosure is not limited thereto. For example, the first and second memory regions MR1 and MR2 may be implemented in other manners. The non-volatile memory device 1120 may be implemented as a Vertical NAND (V-NAND) memory device, and the first and second memory regions MR1 and MR2 may be distinguished from each other depending on a spaced distance in a direction perpendicular to a substrate.

The first and second memory regions MR1 and MR2 may be distinguished from each other by various factors such as the number of program/erase (P/E) cycles, programmed bit values, an uncorrected bit error rate (UBER), a NAND die failure rate, the number of initial bad blocks (IBB), an applied process technique, and a device temperature. Alternatively, memory regions may be implemented in three or more types.

In operation S110, the sensor device 1200 may provide the environment data DTe to the storage device 1100. The environment data DTe may indicate the ambient environment of the vehicle 1000 sensed by the sensor device 1200.

For example, the environment data DTe may include at least one of image information around the vehicle 1000, sensing information of an object (e.g., an obstacle, a pedestrian, or another vehicle) around the vehicle 1000, position information of the vehicle 1000, moving direction information of the vehicle 1000, speed information of the vehicle 1000, and brake system status information of the vehicle 1000.

In operation S120, the message manager 1111 of the storage controller 1110 may generate the message data DTm based on the environment data DTe. Alternatively, the message manager 1111 may receive message data from another vehicle through a communication device mounted on the vehicle 1000 and may generate the message data DTm based on the received message data. The message data DTm may include information contributing to the driving of the vehicle 1000. The field of the message data DTm may include period information indicating a maximally allowed response time. As the maximally allowed response time becomes shorter, the importance of the corresponding message data DTm may become higher.

The message manager 1111 of the storage controller 1110 may identify another vehicle by the communication device mounted on the vehicle 1000 and may transmit the message data DTm to the vehicle identified through the communication device. The storage controller 1110 may contribute to cooperative autonomous driving between the vehicle 1000 and another vehicle based on the message data DTm.

The message manager 1111 of the storage controller 1110 may store the field of the message data DTm in the first memory region MR1 or the second memory region MR2, depending on the period information of the field of the message manager 1111.

For example, when the maximally allowed response time corresponding to the period information is shorter than a threshold time, the message manager 1111 may store the field of the message data DTm in the first memory region MR1.

As another example, when the maximally allowed response time corresponding to the period information is not shorter than the threshold time, the message manager 1111 may store the field of the message data DTm in the second memory region MR2.

As described above, according to the vehicle 1000, the storage device 1100 may generate the message data DTm. By contrast, in the related vehicle VE of FIG. 2, the message data DTm may be generated only by the host device. However, according to embodiments, a function of generating the message data DTm may be off-loaded from the host device to the storage device 1100.

According to the above description, even though the vehicle 1000 does not include the host device or the host device of the vehicle 1000 does not support the message data DTm, the storage device 1100 may generate the message data DTm, and thus, the vehicle 1000 including the storage device 1100 may provide various functions which are based on the message data DTm.

In addition, because the storage device 1100 internally generates the message data DTm based on the environment data DTe, the transmission of the environment data DTe to the host device may not be required, and the reception of the message data DTm from the host device may not be required. Accordingly, the I/O load of the storage device 1100 may be decreased.

However, the storage device 1100 may not exclude the connection with the host device which generates the message data DTm. The storage device 1100 may store the environment data DTe, may provide the environment data DTe to the host device, and may receive message data from the host device. The storage device 1100 may store fields of various message data DTm in cooperation with the host device.

Also, because the message data DTm are capable of contributing to the safety of driving in addition to the convenience of the vehicle 1000, the maximally allowed response time of the message data DTm may be determined depending on the required performance or importance. The storage device 1100 may refer to the period information indicating the maximally allowed response time of the message data DTm and may determine a memory region, in which the field of the message data DTm will be stored, based on the period information. The storage device 1100 may satisfy the required performance by storing the field of the message data DTm, the maximally allowed response time of which is short, in a memory region with low latency (e.g., in a memory region whose read speed is fast). Because the read delay of the field of the message data DTm is suppressed, the safety may be guaranteed while driving the vehicle 1000.

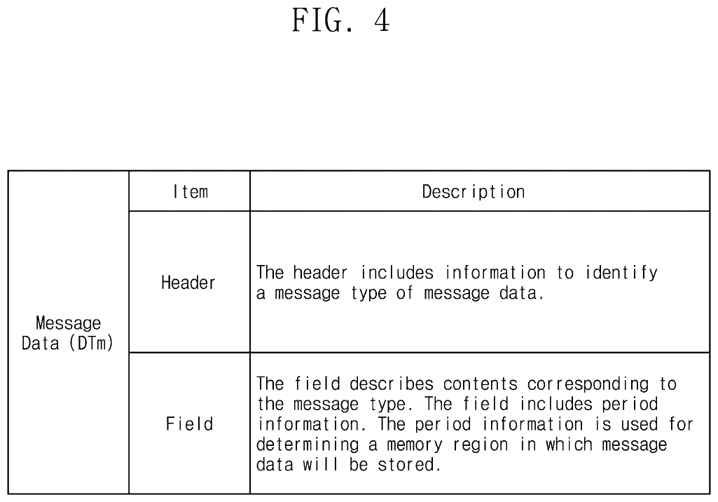

FIG. 4 is a table describing message data according to some embodiments. Items of the message data DTm are described with reference to FIG. 4. The message data DTm may include a header and a field.

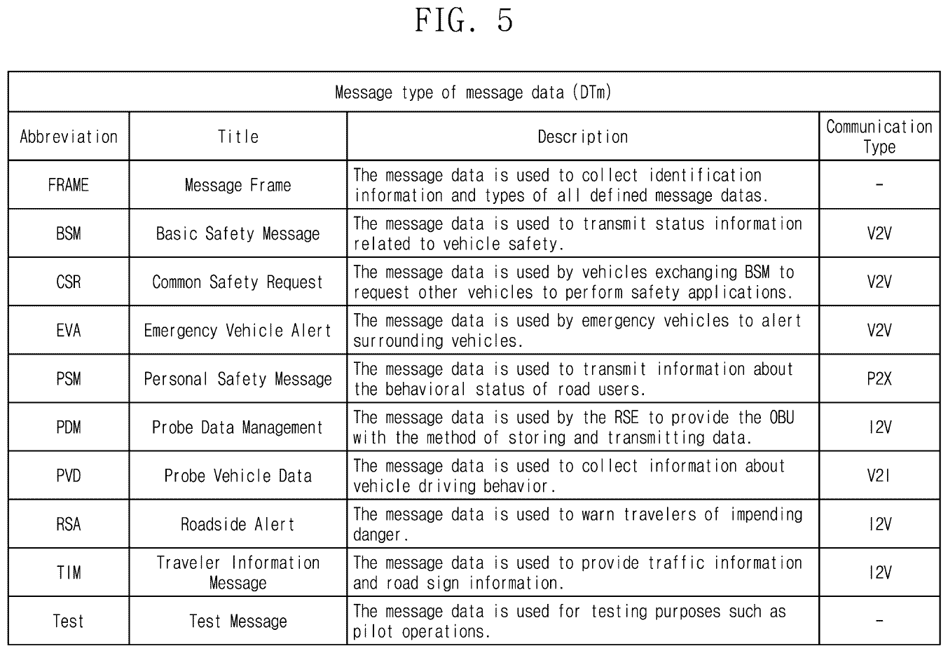

Referring to the header item of the message data DTm, the header may indicate a message type. The header may include information for identifying a message type of the message data DTm. Examples of the message type will be described in detail with reference to FIG. 5.

Referring to the field item of the message data DTm, the field may indicate contents corresponding to a message type. The field may include period information indicating a maximally allowed response time of the message data DTm. The period information may be used for determining a memory region in which the field of the message data DTm will be stored.

FIG. 5 is a table describing a message type of message data according to some embodiments. Examples of the message type of the message data DTm are described with reference to FIG. 5. In some embodiments, the message data DTm may be implemented based on the SAE J2735 standard issued by SAE International. In some embodiments, a header of the message data DTm may include an abbreviation and/or title indicating a message type.

The message type of the message data DTm may correspond to a message frame, a basic safety message, a common safety request, an emergency vehicle alert, a personal safety message, probe data management, probe vehicle data, roadside alert, a traveler information message, or a test message.

When the message type of the message data DTm is the message frame, the abbreviation may be “FRAME” and the associated message data DTm may be used to collect identification information and types of all defined messages. The communication type may depend on a type of a terminal communicating the message data DTm.

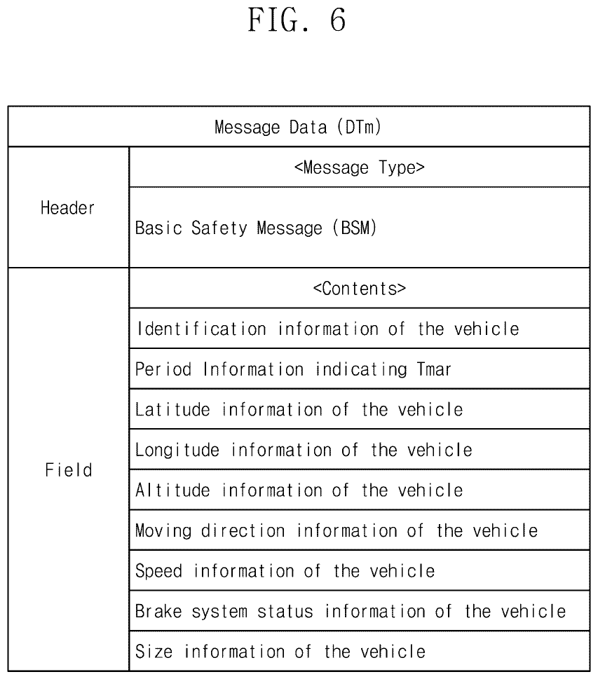

When the message type of the message data DTm is the basic safety message, the abbreviation may be “BSM” and the associated message data DTm may be used to transmit status information related to vehicle safety. The V2V communication type may be applied. The basic safety message will be described in detail with reference to FIG. 6.

When the message type of the message data DTm is the common safety request, the abbreviation may be “CSR” and the associated message data DTm may be used by vehicles exchanging the BSM to request other vehicles to perform safety applications. The V2V communication type may be applied. In some embodiments, the V2V communication type of the unicast manner (i.e., a one-to-one manner) may be applied between a specific vehicle and another specific vehicle.

When the message type of the message data DTm is the emergency vehicle alert, the abbreviation may be “EVA” and the associated message data DTm may be used by emergency vehicles to alert surrounding vehicles. The V2V communication type may be applied.

When the message type of the message data DTm is the personal safety message, the abbreviation may be “PSM” and the associated message data DTm may be used to transmit information about the behavioral status of road users. The pedestrian-to-everything (P2X) communication type may be applied.

When the message type of the message data DTm is the probe data management, the abbreviation may be “PDM” and the associated message data DTm may be used by the RSE to provide an on board unit (OBU) with a method of storing and transmitting data. The OBU may refer to at least some of the components of the vehicle 1000 of FIG. 1. The infrastructure-to-vehicle (I2V) communication type may be applied.

When the message type of the message data DTm is the probe vehicle data, the abbreviation may be “PVD” and the associated message data DTm may be used to collect information about vehicle driving behavior. The vehicle-to-infrastructure (V2I) communication type may be applied.

When the message type of the message data DTm is the roadside alert, the abbreviation may be “RSA” and the associated message data DTm may be used to warn travelers of impending danger. The I2V communication type may be applied.

When the message type of the message data DTm is the traveler information message, the abbreviation may be “TIM” and the associated message data DTm may be used to provide traffic information and road sign information. The I2V communication type may be applied. In some embodiments, in the case of a temporary construction site or an accident site, the OBU of a special vehicle may provide the traveler information message to another terminal based on the V2I communication type.

When the message type of the message data DTm is the test message, the abbreviation may be “Test” and the associated message data DTm may be used for testing purposes such as pilot operations. The communication type may depend on a type of a terminal communicating the message data DTm.

FIG. 6 is a table describing an example of message data according to some embodiments. An example of the message data DTm implemented as the basic safety message is described with reference to FIG. 6.

The header of the message data DTm may indicate a message type. For example, the header may include the abbreviation and/or title of the message type. The message type may correspond to the basic safety message.

The field of the message data DTm may indicate contents corresponding to the message type. The field may include identification information of the vehicle, period information indicating a maximally allowed response time Tmar, latitude information of the vehicle, longitude information of the vehicle, altitude information of the vehicle, moving direction information of the vehicle, speed information of the vehicle, brake system status information of the vehicle, and size information of the vehicle.

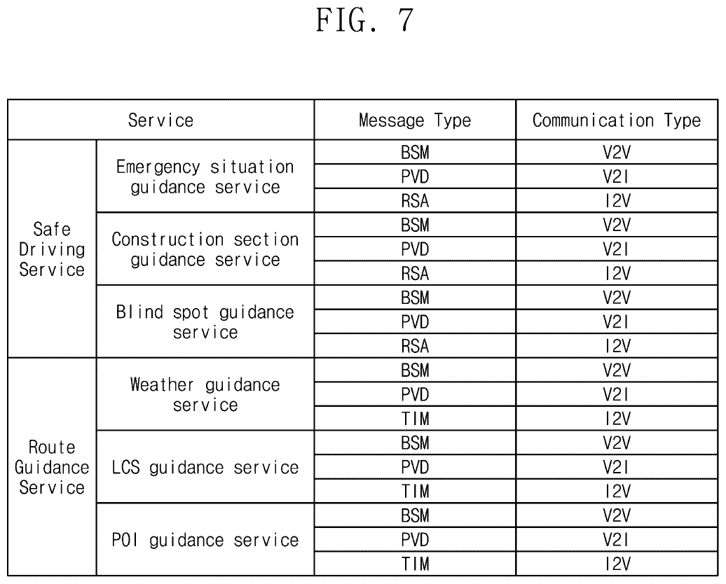

FIG. 7 is a table describing a service according to some embodiments. Examples of a service capable of being provided based on the message data DTm are described with reference to FIGS. 5 and 7. The message data DTm may be used to provide a safe driving service and a route guidance service. The safe driving service may include an emergency situation guidance service, a construction section guidance service, and a blind spot guidance service. The route guidance service may include a weather guidance service, a lane control system (LCS) guidance service, and a point of interest (POI) guidance service.

The emergency situation guidance service may notify the driver or passenger of the vehicle of an emergency situation while driving the vehicle. The emergency situation guidance service may be based on at least one of the basic safety message of the V2V communication type, the probe vehicle data of the V2I communication type, and the roadside alert of the I2V communication type.

The construction section guidance service may notify the driver or passenger of the vehicle of a construction section present on the driving route of the vehicle or adjacent to the driving route. The construction section guidance service may be based on at least one of the basic safety message of the V2V communication type, the probe vehicle data of the V2I communication type, and the road side alert of the I2V communication type.

The blind spot guidance service may notify the driver or passenger of the vehicle of a blind spot difficult for the driver or passenger to identify. The blind spot guidance service may be based on at least one of the basic safety message of the V2V communication type, the probe vehicle data of the V2I communication type, and the road side alert of the I2V communication type.

The weather guidance service may notify the driver or passenger of the vehicle of the weather of a current position of the vehicle or a district corresponding to the driving route of the vehicle. The weather guidance service may be based on at least one of the basic safety message of the V2V communication type, the probe vehicle data of the V2I communication type, and the traveler information message of the I2V communication type.

The LCS guidance service may notify the driver or passenger of the vehicle of a variable operating status of a direction of travel of existing lanes compatible bidirectionally in the driving route of the vehicle or a vehicle travel possible status on the shoulder. The LCS guidance service may be based on at least one of the basic safety message of the V2V communication type, the probe vehicle data of the V2I communication type, and the traveler information message of the I2V communication type.

The POI guidance service may notify the driver or passenger of the vehicle of locations of a rest area, a tourist attraction, etc. within the driving route of the vehicle. The POI guidance service may be based on at least one of the basic safety message of the V2V communication type, the probe vehicle data of the V2I communication type, and the traveler information message of the I2V communication type.

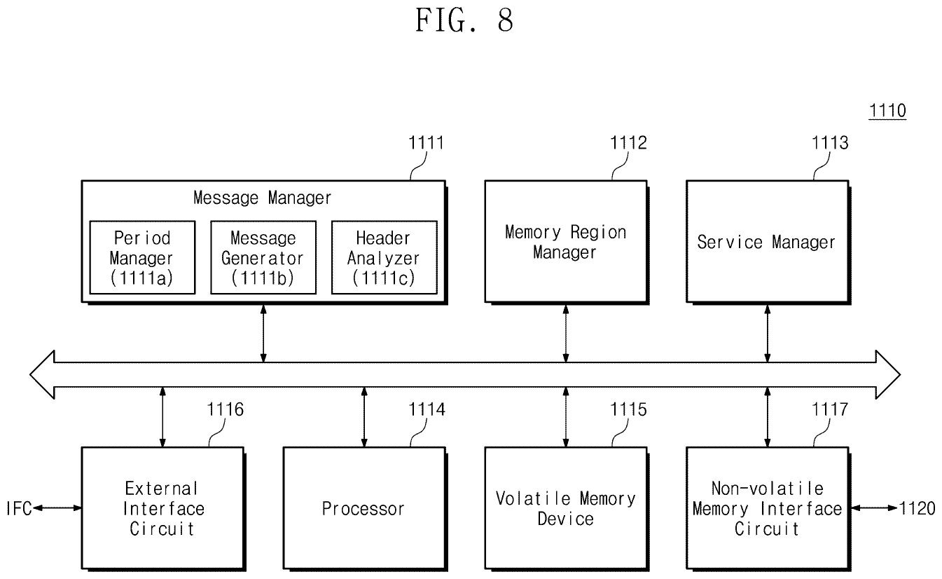

FIG. 8 is a block diagram of a storage controller according to some embodiments. Referring to FIG. 8, the storage controller 1110 may include the message manager (e.g. message management circuit) 1111, a memory region manager (e.g. memory region management circuit) 1112, a service manager (e.g. service management circuit) 1113, a processor 1114, a volatile memory device 1115, an external interface circuit 1116, and a non-volatile memory interface circuit 1117. The storage controller 1110 may communicate with other components of the vehicle 1000 of FIG. 1 through the interface bus circuit IFC. The storage controller 1110 may communicate with the non-volatile memory device 1120 through the non-volatile memory interface circuit 1117.

The message manager 1111 may manage message data. The message manager 1111 may include a period manager 1111a, a message generator 1111b, and a header analyzer 1111c. The period manager 1111a may determine period information indicating a maximally allowed response time of message data. The message generator 1111b may receive the period information from the period manager 1111a and may generate message data including a header and a field based on the period information. The header analyzer 1111c may analyze the header of the message data generated by the message generator 1111b or the header of the message data received from the outside (e.g., the outside of the storage device 1100 of FIG. 1).

The memory region manager 1112 may identify memory regions of the non-volatile memory device 1120, may allocate logical regions corresponding to the memory regions, and may provide allocation information of the logical regions to the message manager 1111. The message manager 1111 may identify the memory regions by using the logical regions of the allocation information and may store the field of the message data in at least some of the identified memory regions.

The service manager 1113 may read the field of the message data stored in the non-volatile memory device 1120 and may provide the passenger of the vehicle with the safe driving service or the route guidance service based on the field of the message data thus read. For example, the service manager 1113 may provide the passenger of the vehicle with at least some of the services of FIG. 7, that is, the emergency situation guidance service, the construction section guidance service, the blind spot guidance service, the weather guidance service, the LCS guidance service, and the POI guidance service.

The processor 1114 may control all operations of the storage controller 1110. The volatile memory device 1115 may be implemented as a main memory or a cache memory of the storage controller 1110. In some embodiments, the volatile memory device 1115 may be implemented with a static random access memory (SRAM), a dynamic random access memory (DRAM), etc.

In some embodiments, at least some of the functions of the message manager 1111, the memory region manager 1112, and the service manager 1113 may be implemented as hardware operating according to software instructions.

For example, the non-volatile memory device 1120 may store instructions describing the functions implemented by the software module. The processor 1114 may load the instructions stored in the non-volatile memory device 1120 to the volatile memory device 1115. The volatile memory device 1115 may temporarily store the loaded instructions. The processor 1114 may implement the functions implemented by the software module by executing the instructions loaded to the volatile memory device 1115.

The external interface circuit 1116 may be connected to the interface bus circuit IFC. The storage controller 1110 may communicate with at least one of the sensor device 1200, the communication device 1300, the user interface device 1400, and the vehicle control device 1500 of FIG. 1 through the external interface circuit 1116 and the interface bus circuit IFC.

The non-volatile memory interface circuit 1117 may be connected to the non-volatile memory device 1120. The storage controller 1110 may communicate with the non-volatile memory device 1120 through the non-volatile memory interface circuit 1117. For example, the non-volatile memory interface circuit 1117 may be implemented based on the NAND interface.

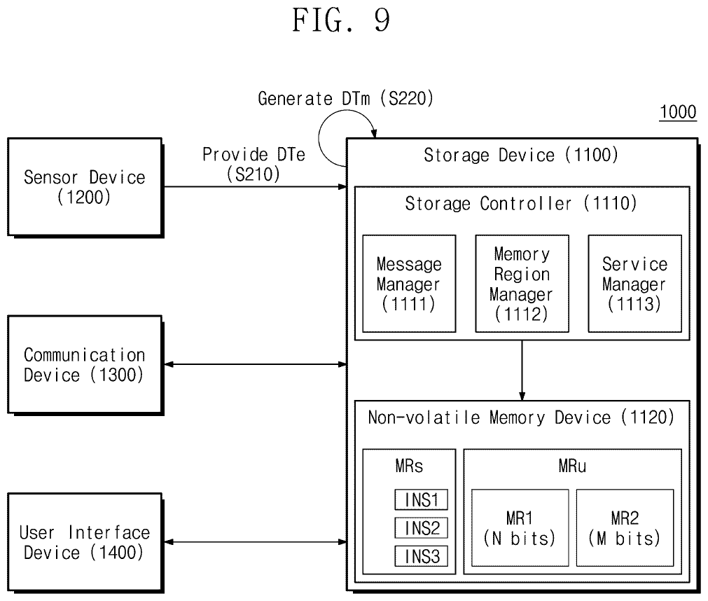

FIG. 9 is a diagram describing a method of operating a vehicle according to some embodiments. Referring to FIG. 9. the vehicle 1000 may include the storage device 1100, the sensor device 1200, the communication device 1300, and the user interface device 1400. The storage device 1100 may include the storage controller 1110 and the non-volatile memory device 1120. The storage controller 1110 may implement the message manager 1111, the memory region manager 1112, and the service manager 1113. The non-volatile memory device 1120 may include the software memory region MRs and the user memory region MRu.

The software memory region MRs may include first instructions INS1 corresponding to the message manager 1111, second instructions INS2 corresponding to the memory region manager 1112, and third instructions INS3 corresponding to the service manager 1113. The user memory region MRu may include the first memory region MR1 and the second memory region MR2. A first read speed corresponding to the first memory region MR1 may be faster than a second read speed corresponding to the second memory region MR2.

For example, each of first memory cell transistors of the first memory region MR1 may store N-bit information. Each of second memory cell transistors of the second memory region MR2 may store M-bit information. “N” is a natural number. “M” is a natural number greater than “N”.

The storage controller 1110 may load the first instructions INS1 of the software memory region MRs and may implement the message manager 1111 by executing the first instructions INS1 thus loaded. As in the above description, the storage controller 1110 may load the second instructions INS2 of the software memory region MRs and may implement the memory region manager 1112 by executing the second instructions INS2 thus loaded. The storage controller 1110 may load the third instructions INS3 of the software memory region MRs and may implement the service manager 1113 by executing the third instructions INS3 thus loaded.

Below, a method of operating the vehicle 1000 will be described.

In operation S210, the sensor device 1200 may provide the environment data DTe to the storage device 1100. For example, the sensor device 1200 may be mounted on the vehicle 1000. The sensor device 1200 may sense an ambient environment of the vehicle 1000, may generate the environment data DTe indicating the sensed ambient environment, and may provide the environment data DTe to the storage device 1100 mounted on the vehicle 1000.

In operation S220, the storage device 1100 may generate the message data DTm based on the environment data DTe. For example, the message manager 1111 may receive the environment data DTe from the sensor device 1200 and may generate the message data DTm contributing to the driving of the vehicle 1000 based on the environment data DTe.

The storage device 1100 may support the cooperative autonomous driving function based on the message data DTm. For example, referring to FIGS. 8 and 9 together, the message manager 1111 may include the period manager 1111a and the message generator 1111b. The period manager 1111a may identify at least one other vehicle within a communication range through the communication device 1300 mounted on the vehicle 1000. The period manager 1111a may determine period information based on the at least one other vehicle thus identified. The period manager 1111a may provide the period information to the message generator 1111b. The message generator 1111b may generate the message data DTm based on the period information. The message generator 1111b may broadcast the message data DTm through the communication device 1300 based on the period information. The broadcast message data DTm may be provided to at least one other vehicle within the communication range.

As in the above description, the vehicle 1000 and the at least one other vehicle within the communication range may exchange the message data bidirectionally. The vehicle 1000 and the at least one other vehicle within the communication range may implement the cooperative autonomous driving function based on the exchanged message data.

The storage device 1100 may store the field of the message data DTm. For example, the message manager 1111 may store the field of the message data DTm in the user memory region MRu of the non-volatile memory device 1120.

In some embodiments, the message manager 1111 may determine a memory region, in which the field of the message data DTm will be stored, depending on the importance of the field of the message data DTm. For example, the message manager 1111 may determine whether a maximally allowed response time corresponding to the period information of the field of the message data DTm is shorter than the threshold time. In response to determining that the maximally allowed response time is shorter than the threshold time, the message manager 1111 may store the field of the message data DTm in the first memory region MR1 of the user memory region MRu. In response to determining that the maximally allowed response time is not shorter than the threshold time, the message manager 1111 may store the field of the message data DTm in the second memory region MR2 of the user memory region MRu.

In some embodiments, the memory region manager 1112 may manage the user memory region MRu. For example, the memory region manager 1112 may identify the first and second memory regions MR1 and MR2 of the user memory region MRu of the non-volatile memory device 1120, may allocate a first logical region corresponding to the first memory region MR1, may allocate a second logical region corresponding to the second memory region MR2, and may manage the first and second memory regions MR1 and MR2. The memory region manager 1112 may provide allocation information of the first and second logical regions to the message manager 1111.

In some embodiments, the service manager 1113 may provide a service to the driver or passenger of the vehicle 1000 based on the message data DTm. For example, the service manager 1113 may read the field of the message data DTm stored in the user memory region MRu of the non-volatile memory device 1120. The service manager 1113 may provide the driver or passenger of the vehicle with at least one of the emergency situation guidance service, the construction section guidance service, the blind spot guidance service, the weather guidance service, the LCS guidance service, and the POI guidance service, based on the field of the message data DTm thus read.

As described above, according to embodiments, without a separate host device, the vehicle 1000 may internally generate the message data DTm by using the storage device 1100. As the message data DTm are generated by the storage device 1100 instead of the host device, the I/O load of the storage device 1100 may decrease. Also, assuming that the vehicle 1000 is a related vehicle that does not support a function related to the message data DTm upon manufacturing, as the storage device 1100 is mounted on the vehicle 1000, the vehicle 1000 may expand the function of the vehicle 1000 such that the function related to the message data DTm is supported. However, the present disclosure does not exclude the combination with the host device, which supports the storage device 1100 and the function of the message data DTm within the vehicle 1000.

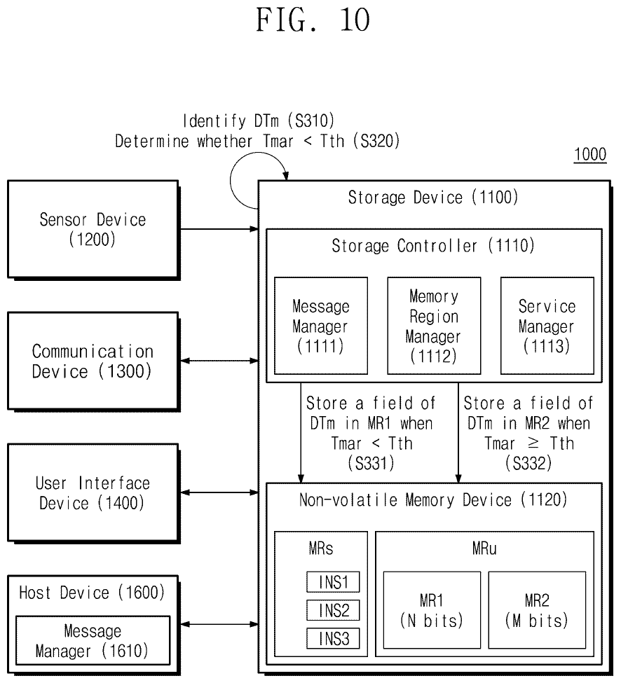

FIG. 10 is a diagram describing a method of operating a vehicle according to some embodiments. Referring to FIG. 10, the vehicle 1000 may include the storage device 1100, the sensor device 1200, the communication device 1300, the user interface device 1400, and a host device 1600. The storage controller 1110 may include the message manager 1111, the memory region manager 1112, and the service manager 1113. The non-volatile memory device 1120 may include the software memory region MRs and the user memory region MRu. The user memory region MRu may include the first memory region MR1 and the second memory region MR2. A first read speed corresponding to the first memory region MR1 may be faster than a second read speed corresponding to the second memory region MR2.

Functions of the storage device 1100, the sensor device 1200, the communication device 1300, and the user interface device 1400 are similar to the functions of the storage device 1100, the sensor device 1200, the communication device 1300, and the user interface device 1400 described with reference to FIG. 9, and thus, additional description associated with the same functions will be omitted to avoid redundancy.

The message manager 1111 may receive environment data from the sensor device 1200 and may generate the message data DTm based on the environment data. In addition, the message manager 1111 may manage the message data DTm received from other components.

For example, through the communication device 1300, the message manager 1111 may receive the message data DTm from another vehicle, an RSE, or a user terminal of a pedestrian which is placed outside the vehicle 1000 within the communication range.

As another example, the host device 1600 may implement a message manager 1610. The host device 1600 may be also referred to as an “electronic control unit (ECU)” of the vehicle 1000. The message manager 1610 may receive the environment data from the storage device 1100, may generate the message data DTm based on the environment data, and may provide the message data DTm to the message manager 1111. The message manager 1610 may generate the message data DTm whose type is different from that of the message data DTm generated by the message manager 1111, may generate the message data DTm instead of the message manager 1111, or may generate the message data DTm in cooperation with the message manager 1111.

Below, a method of operating the vehicle 1000 will be described.

In operation S310, the storage device 1100 may identify the message data DTm. For example, the message manager 1111 may identify the message data DTm contributing to the driving of the vehicle 1000. The message data DTm is not limited as being generated by the storage device 1100.

In detail, before identifying the message data DTm, the message manager 1111 may receive the environment data from the sensor device 1200 mounted on the vehicle 1000 and may generate the message data DTm based on the environment data. Before identifying the message data DTm, the message manager 1111 may receive the message data DTm from the message manager 1610 of the host device 1600 mounted on the vehicle 1000. Alternatively, before identifying the message data DTm, the message manager 1111 may receive the message data DTm from another vehicle, an RSE, or a user terminal of a pedestrian, which is placed outside the vehicle 1000 within the communication range, through the communication device 1300 mounted on the vehicle 1000.

In operation S320, the message manager 1111 may determine whether the maximally allowed response time Tmar corresponding to the period information of the field of the message data DTm is shorter than a threshold time Tth. When the maximally allowed response time Tmar is shorter than the threshold time Tth, the message manager 1111 may perform operation S331. When the maximally allowed response time Tmar is not shorter than the threshold time Tth, the message manager 1111 may perform operation S332.

In operation S331, in response to determining that the maximally allowed response time Tmar is shorter than the threshold time Tth, the message manager 1111 may store the field of the message data DTm in the first memory region MR1. The first memory region MR1 may include a plurality of first memory cell transistors, each of which stores N-bit information. “N” is a natural number.

In operation S332, in response to determining that the maximally allowed response time Tmar is not shorter than the threshold time Tth, the message manager 1111 may store the field of the message data DTm in the second memory region MR2. The second memory region MR2 may include a plurality of second memory cell transistors, each of which stores M-bit information. “M” is a natural number greater than “N”.

As described above, according to embodiments, by referring to the field of the message data DTm, the storage device 1100 may store the field of the message data DTm, the maximally allowed response time Tmar of which is short, in a memory region with low latency. According to the above description, the required performance of the vehicle 1000 equipped with the storage device 1100 may be satisfied, the fast read speed of the field of the important message data DTm may be guaranteed, and the safety may be guaranteed while driving the vehicle 1000.

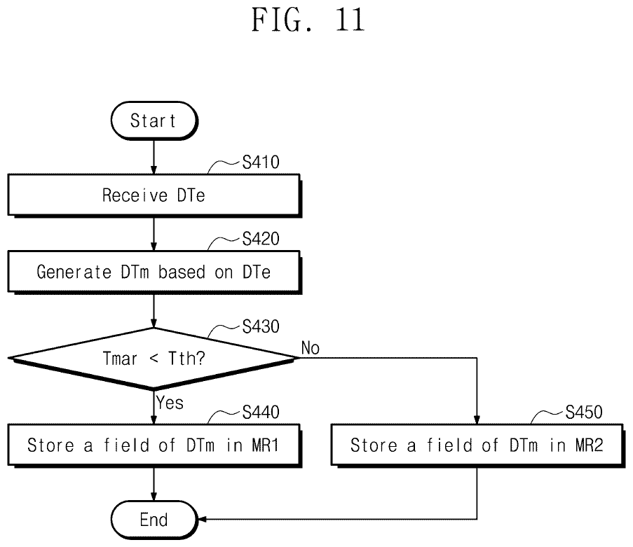

FIG. 11 is a flowchart describing a method of operating a storage device, according to some embodiments. Referring to FIG. 11, a storage device and a sensor device may be mounted on a vehicle. Below, a method of operating the storage device will be described.

In operation S410, the storage device may receive the environment data DTe of the vehicle from the sensor device mounted on the vehicle. The environment data DTe may indicate the ambient environment of the vehicle sensed by the sensor device.

In operation S420, the storage device may generate the message data DTm contributing to the driving of the vehicle based on the environment data DTe. The message data DTm may include a header and a field. The header may indicate a message type of the message data DTm. For example, the header may include an abbreviation and/or a title indicating the message type of the message data DRm. The field may describe contents corresponding to the message type. The field may include period information indicating the maximally allowed response time Tmar.

In operation S430, the message manager 1111 may determine whether the maximally allowed response time Tmar corresponding to the period information of the field of the message data DTm is shorter than the threshold time Tth. When the maximally allowed response time Tmar is shorter than the threshold time Tth, the storage device may perform operation S440.

In operation S440, in response to determining that the maximally allowed response time Tmar is shorter than the threshold time Tth, the storage device may store the field of the message data DTm in the first memory region MR1 among the first memory region MR1 and the second memory region MR2 of the storage device. A first read speed corresponding to the first memory region MR1 may be faster than a second read speed corresponding to the second memory region MR2.

Returning to operation S430, when the maximally allowed response time Tmar is not shorter than the threshold time Tth, the storage device may perform operation S450.

In operation S450, in response to determining that the maximally allowed response time Tmar is not shorter than the threshold time Tth, the storage device may store the field of the message data DTm in the second memory region MR2 among the first memory region MR1 and the second memory region MR2 of the storage device.

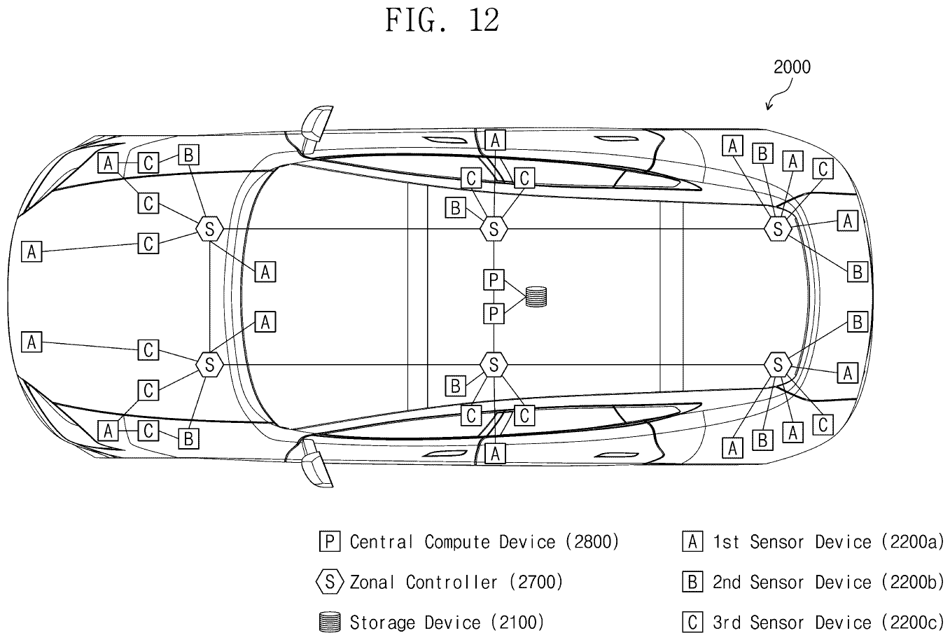

FIG. 12 is a diagram describing an example of a vehicle according to some embodiments. Referring to FIG. 12, a vehicle 2000 may be implemented based on a zonal architecture.

The vehicle 2000 may include a storage device 2100, first sensor devices 2200a, second sensor devices 2200b, third sensor devices 2200c, zonal controllers 2700, and central compute devices 2800. The storage device 2100 may correspond to the storage device 1100 of FIGS. 1, 3, 9, and 10. Each of the sensor devices 2200a, 2200b, and 2200c may correspond to the sensor device 1200 of FIGS. 1, 3, 9, and 10.

The sensor devices 2200a, 2200b, and 2200c may be referred to as “edge devices”. The edge devices may collect or generate sensing information about an external environment of the vehicle 2000 or a status of the vehicle 2000. An edge device may communicate with another edge device or the zonal controller 2700.

The zonal controllers 2700 may communicate with the edge devices directly or indirectly. The zonal controllers 2700 may receive the sensing information from the edge devices and may generate zonal information based on the sensing information.

The central compute devices 2800 may communicate with the zonal controllers 2700 directly or indirectly. The central compute devices 2800 may receive zonal information from the zonal controllers 2700, may generate environment data based on the zonal information, and may store the environment data in the storage device 2100. The environment data may indicate the ambient environment of the vehicle 2000.

The storage device 2100 may receive the environment data from the central compute devices 2800 and may generate message data based on the environment data. The message data may contribute to the driving of the vehicle 2000.

As described above, according to embodiments, as the zonal architecture is applied to the vehicle 2000, the sensor devices 2200a, 2200b, and 2200c of the vehicle 2000 may be integrally managed by the zonal controllers 2700 and the central compute devices 2800. According to the above description, the wire routing and power supply of the vehicle 2000 may be simplified, an edge device with the same function may be removed, the integral management by the software module may become easy, and the update of the software module may become easy. The storage device 2100 may efficiently obtain environment data based on sensor devices disposed depending on the zonal architecture and may generate message data.

According to an embodiment, a storage device mounted on a vehicle and a method of operating the same are provided.

Also, a storage device which reduce an input/output (I/O) load by generating message data instead of a host device and expands a function of a vehicle and a method of operating the same are provided. In addition, a storage device which satisfies the required performance of the vehicle by storing a field of the message data, the maximally allowed response time of which is short, in a memory region with a low latency by referring to the field of the message data and a method of operating the same are provided.

In some embodiments, each of the components represented by a block as illustrated in FIGS. 1, 3, 8-10 and 12 may be implemented as various numbers of hardware and/or firmware structures that execute respective functions described above, according to example embodiments. For example, at least one of these components may include various hardware components including a digital circuit, a programmable or non-programmable logic device or array, an application specific integrated circuit (ASIC), transistors, capacitors, logic gates, or other circuitry using use a direct circuit structure, such as a memory, a processor, a logic circuit, a look-up table, etc., that may execute the respective functions through controls of one or more microprocessors or other control apparatuses. Also, at least one of these components may further include or may be implemented by a processor such as a central processing unit (CPU) that performs the respective functions, a microprocessor, or the like. Functional aspects of example embodiments may be implemented in algorithms that execute on one or more processors. Furthermore, the components, elements, modules or units represented by a block or processing steps may employ any number of related art techniques for electronics configuration, signal processing and/or control, data processing and the like.

While aspects of embodiments have been particularly shown and described, it will be understood that various changes in form and details may be made therein without departing from the spirit and scope of the following claims.

What is claimed is:

1. A storage device comprising:
a non-volatile memory device comprising a software memory region configured to store first instructions; and
a storage controller configured to implement a message manager by executing the first instructions,
wherein the message manager is configured to:
receive environment data of a vehicle from a sensor device mounted on the vehicle; and
generate message data configured to contribute to driving of the vehicle based on the environment data.

2. The storage device of claim 1, wherein the storage controller comprises:
a volatile memory device configured to temporarily store the first instructions; and
a processor configured to implement the message manager by executing the first instructions.

3. The storage device of claim 1, wherein the environment data comprise at least one of image information, sensing information indicating an external object, position information of the vehicle, moving direction information of the vehicle, speed information of the vehicle, and brake system status of the vehicle.

4. The storage device of claim 1, wherein the message data comprises:
a header indicating a message type; and
a field describing contents corresponding to the message type and comprising period information indicating a maximally allowed response time.

5. The storage device of claim 4, wherein the message type corresponds to a basic safety message, a common safety request, an emergency vehicle alert, or probe vehicle data.

6. The storage device of claim 4, wherein the message type corresponds to a basic safety message, and
wherein the field further comprises identification information of the vehicle, latitude information of the vehicle, longitude information of the vehicle, altitude information of the vehicle, moving direction information of the vehicle, speed information of the vehicle, brake system status information of the vehicle, and size information of the vehicle.

7. The storage device of claim 1, wherein the non-volatile memory device further comprises a user memory region,
wherein the user memory region comprises a first memory region and a second memory region,
wherein a first read speed corresponding to the first memory region is faster than a second read speed corresponding to the second memory region, and
wherein the message manager is configured to:
determine whether a maximally allowed response time corresponding to period information of a field of the message data is shorter than a threshold time;
store the field of the message data in the first memory region of the user memory region in response to determining that the maximally allowed response time is shorter than the threshold time; and
store the field of the message data in the second memory region of the user memory region in response to determining that the maximally allowed response time is not shorter than the threshold time.

8. The storage device of claim 7, wherein the first memory region comprises a plurality of first memory cell transistors, each of which is configured to store N-bit information,
wherein the second memory region comprises a plurality of second memory cell transistors, each of which is configured to store M-bit information, and
wherein “N” and “M” are natural numbers, and “M” is greater than “N”.

9. The storage device of claim 7, wherein the software memory region is further configured to store second instructions,
wherein the storage controller is further configured to implement a memory region manager by executing the second instructions, and
wherein the memory region manager is configured to:
identify the first memory region and the second memory region of the user memory region of the non-volatile memory device;
allocate a first logical region of the non-volatile memory device to the first memory region;
allocate a second logical region of the non-volatile memory device to the second memory region; and
manage the first memory region and the second memory region.

10. The storage device of claim 1, wherein the software memory region is further configured to store third instructions,
wherein the storage controller is further configured to implement a service manager by executing the third instructions, and
wherein the service manager is configured to provide a driver or passenger of the vehicle with at least one of an emergency situation guidance service, a construction section guidance service, a blind spot guidance service, a weather guidance service, a lane control system (LCS) guidance service, and a point of interest (POI) guidance service, based on the message data.

11. The storage device of claim 1, wherein the message manager comprises:
a period manager configured to determine period information indicating a maximally allowed response time of the message data;
a message generator configured to receive the period information from the period manager and to generate the message data comprising a header and a field based on the period information; and
a header analyzer configured to analyze the header.

12. The storage device of claim 11, wherein the period manager is configured to:
identify at least one other vehicle within a communication range through a communication device of the vehicle; and
determine the period information based on information about the at least one other vehicle, and
wherein the message generator is further configured to broadcast the message data through the communication device based on the period information.

13. A storage device comprising:
a non-volatile memory device comprising a first memory region, a second memory region, and a software memory region configured to store instructions; and
a storage controller configured to implement a message manager by executing the instructions,
wherein a first read speed corresponding to the first memory region is faster than a second read speed corresponding to the second memory region, and
wherein the message manager is configured to:
identify message data configured to contribute to driving of a vehicle;
determine whether a maximally allowed response time corresponding to period information of a field of the message data is shorter than a threshold time;
store the field of the message data in the first memory region in response to determining that the maximally allowed response time is shorter than the threshold time; and
store the field of the message data in the second memory region in response to determining that the maximally allowed response time is not shorter than the threshold time.

14. The storage device of claim 13, wherein the storage controller comprises:
a volatile memory device configured to temporarily store the instructions; and
a processor configured to implement the message manager by executing the instructions.

15. The storage device of claim 13, wherein the first memory region comprises a plurality of first memory cell transistors, each of which stores N-bit information,
wherein the second memory region comprises a plurality of second memory cell transistors, each of which stores M-bit information, and
wherein “N” and “M” are natural numbers, and “M” is greater than “N”.

16. The storage device of claim 13, wherein the message manager is configured to:
generate the message data based on environment data received from a sensor device mounted on the vehicle; and
receive the message data from an external host device, another vehicle, roadside equipment (RSE), or a user terminal of a pedestrian through a communication device of the vehicle.

17. The storage device of claim 13, wherein the message data comprises:
a header indicating a message type; and
a field describing contents corresponding to the message type and comprising the period information indicating the maximally allowed response time, and
wherein the message type corresponds to a basic safety message, a common safety request, an emergency vehicle alert, a personal safety message, probe data management, probe vehicle data, roadside alert, or a traveler information message.

18. A method of operating a storage device which is mounted on a vehicle, the method comprising:
receiving environment data of the vehicle from a sensor device mounted on the vehicle;
generating message data configured to contribute to driving of the vehicle based on the environment data, wherein the message data comprises a header and a field;
determining whether a maximally allowed response time corresponding to period information of the field of the message data is shorter than a threshold time; and
storing the field of the message data in a first memory region among the first memory region and a second memory region of the storage device in response to determining that the maximally allowed response time is shorter than the threshold time,
wherein a first read speed corresponding to the first memory region is faster than a second read speed corresponding to the second memory region.

19. The method of claim 18, further comprising storing the field of the message data in the second memory region of the storage device in response to determining that the maximally allowed response time is not shorter than the threshold time.

20. The method of claim 18, wherein the header of the message data indicates a message type, and
wherein the message type corresponds to a basic safety message, a common safety request, an emergency vehicle alert, or probe vehicle data.
